(19) United States
(12) Patent Application Publication
(10) Pub. No.: US 2013/0294813 A1
(43) Pub. Date: Nov. 7, 2013

(54) Modular Binder System

(71) Applicant: Radian Development, LLC, Charlotte, NC (US)

(72) Inventor: David W. Burns, Charlotte, NC (US)

(73) Assignee: Radian Development, LLC, Charlotte, NC (US)

(21) Appl. No.: 13/798,849

(22) Filed: Mar. 13, 2013

Related U.S. Application Data
(60) Provisional application No. 61/640,762, filed on May 1, 2012.

(51) Int. Cl. B42F 23/00

(52) U.S. Cl. CPC B42F 23/00
USPC 402/73

(57) ABSTRACT

A flexible spine having a number of pivotally connected spine modules. A first detent lock portion included on a first spine module and a second detent lock portion included on a second adjacent spine module for releasably interlocking adjacent spine modules. An accessory channel included in at least one of the spine modules. An accessory module including a hinge connector adapted for being received into the accessory channel and carrying an accessory panel. At least one retainer prong disposed in the accessory channel engaging the hinge connector for resisting movement of the hinge connector in the accessory channel.

### BACKGROUND OF THE INVENTION

1) Field of the Invention

The present invention relates to personal organizer systems for papers and the like, and more particularly, to a binder having a flexible modular spine for receiving various accessory attachments to create a customized binder.

2) Description of Related Art

The prior art is replete with various type of personal organizer binder systems that have binder rings or other securing means capable of receiving a variety of attachments and holding them between a top and bottom cover. The problem with existing binder systems of this type is that they tend to be fixed items with no ability to expand or adapt to accommodate a variety of accessory items. For example, US Patent Application Publication No. 2010/0247227 discloses a modular locking binder system in which the internal dividers are interchangeable by sliding into a slotted spine section. The covers and spine are a single fixed arrangement component that cannot be expanded, or reduced to customize the binder. Other binder systems that utilize modular construction are not designed for personal organizational needs, but rather for binding large volumes of material. Such systems are entirely unusable in, for example, a classroom environment.

Accordingly, it is an object of the present invention to provide a modular binder system for personal organizer needs in which the spine, covers, and accessory attachments are constructed and arranged as modular components to fully customize the binder arrangement.

It is a further object of the present invention to securely interconnect the modular components to avoid accidental separation.

### SUMMARY OF THE INVENTION

The above objectives are accomplished according to the present invention by providing a modular binder system comprising a flexible spine defined by a first spine module pivotally connected to at least a second spine module; a first detent lock portion included on the first spine module and a second detent lock portion included on the second spine module for releasably connecting the first and second spine modules; an accessory channel disposed in at least one of the first and second spine modules; an accessory module including a hinge connector adapted for being received into the accessory channel and carrying an accessory panel; and, at least one retainer prong disposed in the accessory channel engaging the hinge connector for resisting movement of the hinge connector in the accessory channel.

In a further advantageous embodiment, the hinge connector includes a non-compressible center cord encased in a flexible sheet material that is secured to an accessory panel, and wherein the center cord is laterally spaced from the accessory panel so that the flexible sheet material forms a flexible hinge section between the center cord and the accessory panel.

In a further advantageous embodiment, the first spine module includes a connecting member and the second spine module includes a complementary connecting channel, wherein the connecting member of the first spine module is pivotally received into the connecting channel of the second spine module.

In a further advantageous embodiment, the connecting member extends along the length of the first spine module and the connecting channel extends along the length of the second spine module for receiving the entire connecting member.

In a further advantageous embodiment, the connecting member is carried at a distal end of a spacer arm so that the connecting member is projected outward, and a pivot gap is defined in a wall of the connecting channel accommodating the spacer arm to allow for the connecting member to be fully received into the connecting channel and the spacer arm to move up or down to create a pivoting connection between the first and second spine modules.

In a further advantageous embodiment, the first detent lock portion is disposed on the connecting member and the second detent lock portion is disposed on the connecting channel for interlocking engagement when the connecting member is received into the connecting channel.

In a further advantageous embodiment, the first detent lock portion includes a spring member operatively associated with an engaging head projecting outward from the connecting member, and a recess is disposed in the connecting member for at least partially receiving the engaging head when depressed so that the connecting member can slide through the connecting channel. In a particular embodiment, the first detent lock portion is defined by a spring arm carrying the engaging head disposed about an arm recess of the connecting member, wherein depressing the engaging head causes the spring arm and engaging head to retract at least partially into the arm recess so that the connecting member can slide through the connecting channel.

In a further advantageous embodiment, the second detent lock portion includes a locking slot disposed along the connecting channel for receiving the engaging head, wherein the spring member directs the engaging head to extend into the locking slot for securing the connecting member in the connecting channel, and depressing the engaging head retracts the engaging head from the locking slot for allowing the connecting member to slide through the connecting channel.

In a further advantageous embodiment, the locking slot provides an opening in the connecting channel in which the engaging head can move laterally to allow for rotation of the connecting member in the connecting channel.

In a further advantageous embodiment, the connecting member is carried at a distal end of a spacer arm, and a pivot gap is defined in a wall of the connecting channel accommodating the spacer arm, wherein pivotal movement of the spacer arm in the pivot gap causes a complementary lateral movement of the engaging head in the locking slot so that the spacer arm can move fully throughout the pivot gap.

In a further advantageous embodiment, the accessory channel includes a hinge gap defined in the walls of the accessory channel allowing the hinge connector of the accessory modules to extend outwardly and bend to pivot the accessory panel.

In a further advantageous embodiment, the at least one retainer prong extends continually along the length of the accessory channel for engaging the hinge connector all the way through the accessory channel.

In a further advantageous embodiment, a first retainer prong is disposed generally opposite a second retainer prong in the accessory channel for engaging the flexible sheet material of the hinge connector to resist movement of the hinge connector in the accessory channel.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective top view of a modular binder system according to the present invention;

FIG. 2 shows a cross-section view of an accessory module according to the present invention;

FIG. 3 a cross-section view of an accessory module disposed in an accessory channel of a spine module according to the present invention;

FIGS. 4A and 4B show an end view of the modular binder system according to the present invention;

FIG. 5A shows a perspective view of a series of interconnected spine modules according to the present invention;

FIG. 5B shows an exploded view of a pair of spine modules according to the present invention;

FIGS. 6A and 6B show a cross-section view of two connected spine modules according to the present invention; and,

FIG. 7 shows a cross-section view of a detent connection between a connecting member and connecting channel of spine modules according to the present invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to specific embodiments, it will be appreciated that the description is illustrative of the invention and is not constructed as limiting of the invention. Various modifications and applications may occur to those who are skilled in the art, without departing from the spirit and the scope of the invention, as described by the appended claims.

### DETAILED DESCRIPTION OF A PREFERRED EMBODIMENT

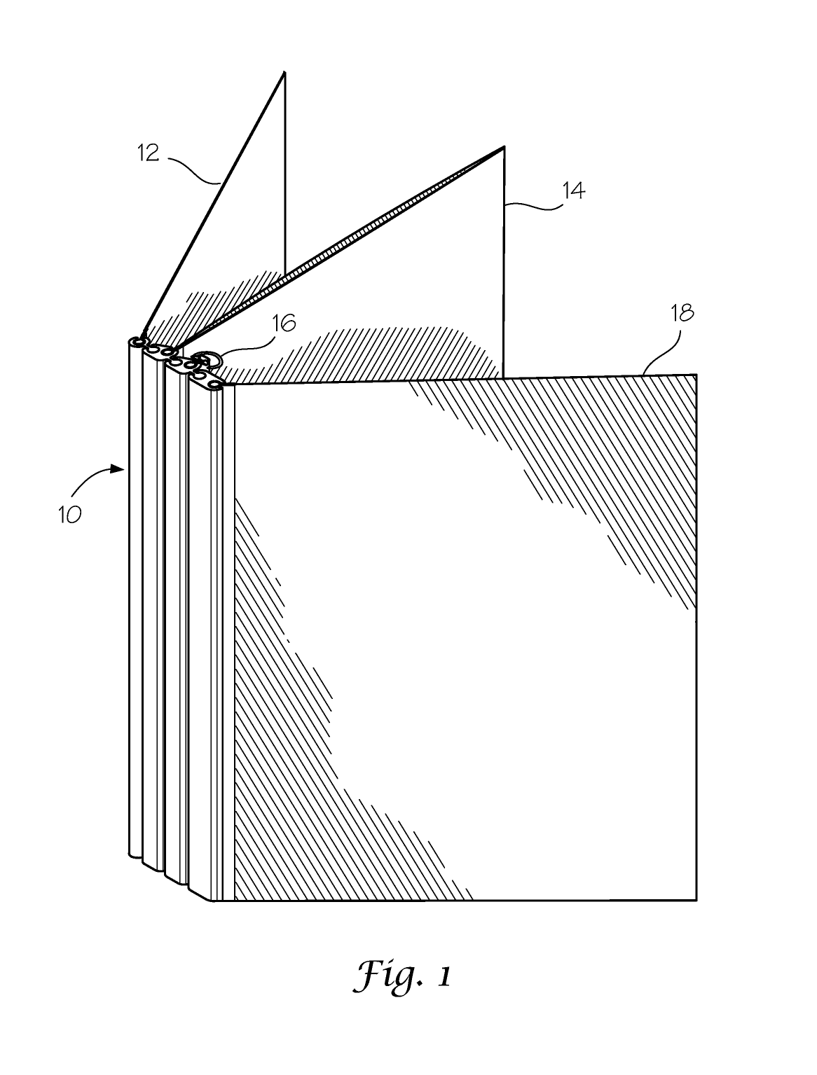

With reference to the drawings, the invention will now be described in more detail. Referring to FIG. 1, a modular binder system is shown having a flexible spine defined by a plurality of pivotally connected spine modules, designated generally as 10, with a plurality of accessory modules 12, 14, 16, 18 releasably connected to the spine modules 10.

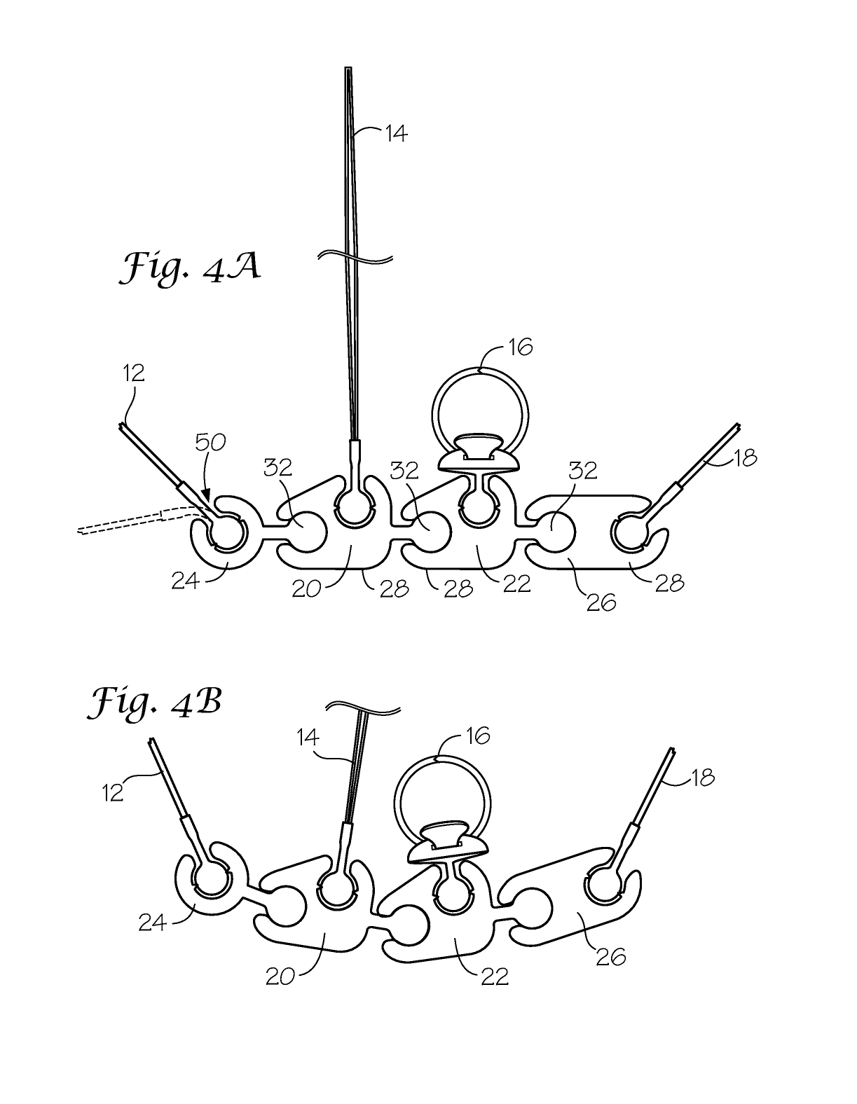

Referring to FIGS. 4A and 4B, in the illustrated arrangement, spine modules 10 includes a first interior spine module 20 connected to a second interior spine module 22, with a first end spine module 24 connected to the first interior spine module 20, and the second end spine module 26 connected to the second interior spine module 22. The first and second interior spine modules 20 and 22 are identical in construction and cooperate by being pivotally connected to each other to allow for articulation to define the flexible spine. The first and second end spine modules 24 and 26 are structurally different as shown but are also pivotally connected to a respective interior spine module 20 and 22.

In the illustrated arrangement, each of interior spine modules 20 and 22 and second end spine module 26 have a generally flat bottom side 28 for lying flat on a surface. As first end module 24 has a general c-shaped structure, it does not include a flat bottom side, but the exterior surface still aligns level with the flat bottom side 28 of the other spine modules when laid flat on a surface.

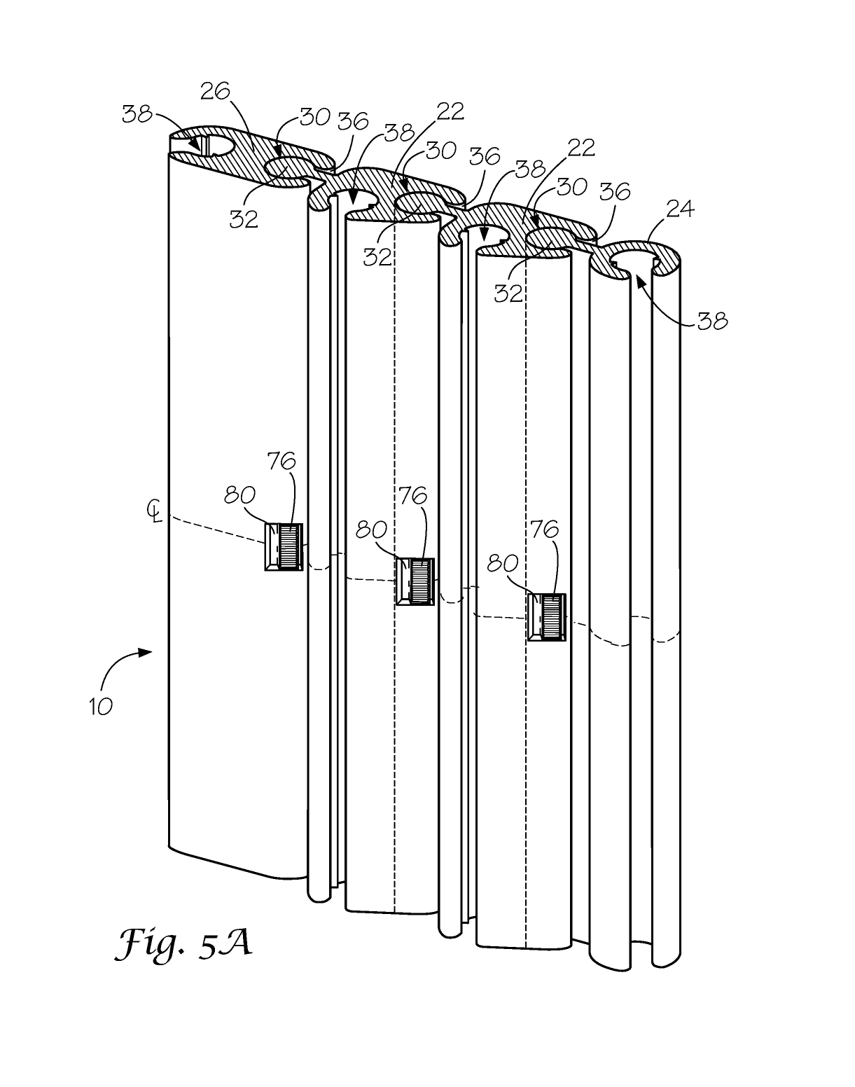

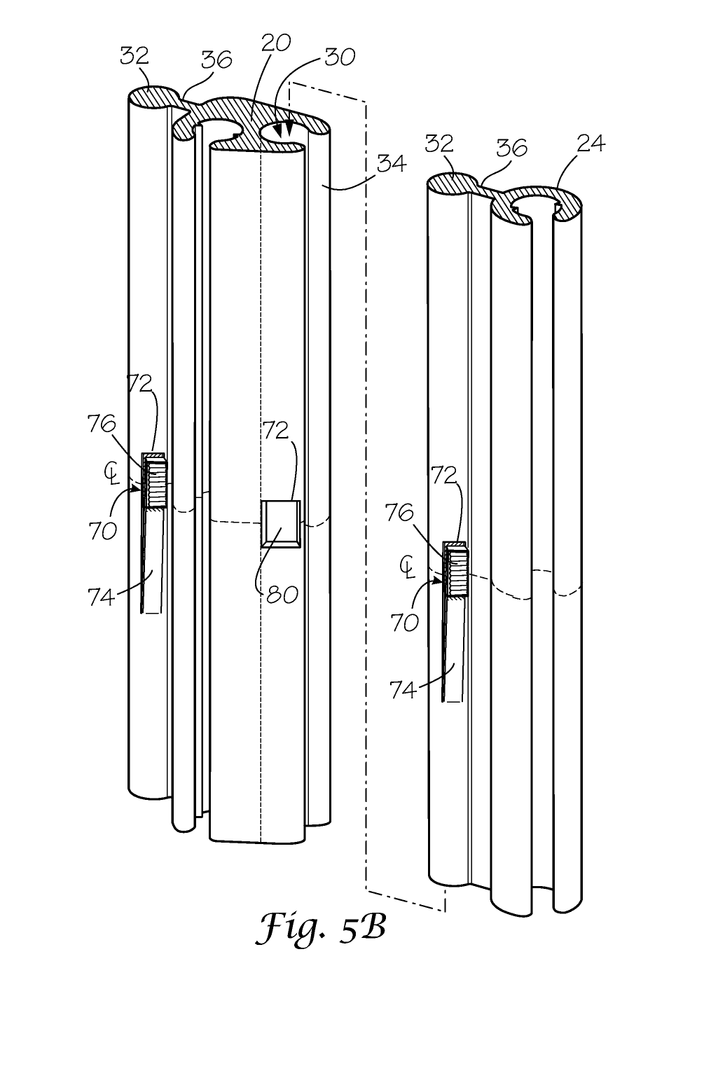

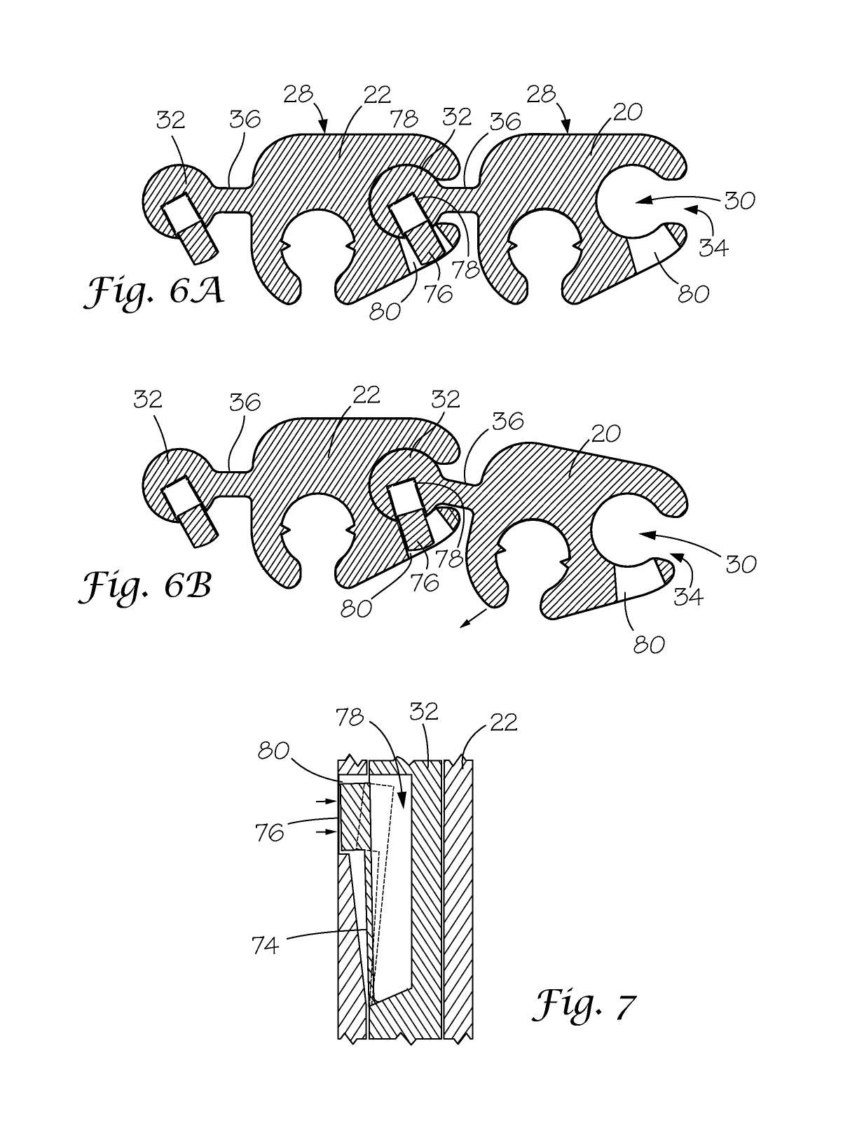

With further reference to FIGS. 5A-6B, a connecting channel 30 extends along the length of interior spine module 20 and 22, as well as second end spine module 26 for receiving a connecting member 32 from an adjacent spine module. First end spine module 24 does not includes a connecting channel 30 as it is unnecessary for that module, but does include connecting member 32 for engaging interior spine module 20. Connecting member 32 is carried at a distal end of a spacer arm 36 so that connecting member 32 is projected outward from the respective spine module. In the illustrated embodiment, connecting member 32 of first interior spine module 20 is received into connecting channel 30 of second interior spine module 22. Accordingly, any number of interior spine modules can be interconnected to expand the flexible spine to accommodate various organizational needs.

As best shown in FIGS. 6A and 6B, a pivot gap 34 is defined in the wall of connecting channel 30. Pivot gap 34 accommodates spacer arm 36 to allow for connecting member 32 to be fully received into connecting channel 30. Pivot gap 34 allows spacer arm 36 to move up or down to create a pivoting connection between each interior spine module 20 and 22. By varying the size of pivot gap 34, the amount of pivoting and articulation between adjacent spine modules can be controlled.

First end spine module 24 is pivotally connected to first interior spine module 20 in the same manner as first interior spine module 20 connects to second interior spine module 22. Accordingly, first end spine module 24 includes a connecting member 32 that is carried at a distal end of a spacer arm 36 so that connecting member 32 is projected outward from the spine module. Also, pivot gap 34 allows spacer arm 36 of first end spine module 24 to move up or down to create a pivoting connection between interior spine module 20 and first end spine module 24.

Second end spine module 26 is pivotally connected to second interior spine module 22 in the same manner as second interior spine module 22 received the connecting member 32 of first interior spine module 20. Accordingly, second end spine module 26 includes a connecting channel 30 extending along its length for receiving connecting member 32 from second interior spine module 22. The connecting channel 30 of second end spine module 26 also includes a pivot gap 34 defined in the wall of connecting channel 30. Pivot gap 34 accommodates spacer arm 36 to allow for connecting member 32 to be fully received into connecting channel 30, as well as for spacer arm 36 to move up or down to create a pivoting connection between second end spine module 26 and second interior spine module 22. Accordingly, spine modules 10 all articulate to provide a flexible spine.

Referring to FIG. 5B, a first detent lock portion, designated generally as 70, is included on a first spine module, for example first end spine module 24, and a second detent lock portion, designated generally as 72, is included on a second adjacent spine module, for example interior spine module 20, for securely and releasably connecting adjacent spine modules.

With further reference to FIGS. 5A-7, in the illustrated embodiment, first detent lock portion 70 is carried by connecting member 32 and second detent lock portion 70 is carried by connecting channel 30 for interlocking engagement when connecting member 32 is received into connecting channel 30.

As best shown in FIG. 7, in the embodiment show, first detent lock portion 70 includes a spring member 74 operatively associated with an engaging head 76 projecting outward from connecting member 32. A recess 78 is disposed in connecting member 32 for at least partially receiving engaging head 76 when depressed so that connecting member 32 can slide through connecting channel 30. In the particular embodiment, first detent lock portion 70 is constructed and arranged in which spring member 74 is a spring arm carrying engaging head 76 in an arm recess 78 formed into connecting member 32. Accordingly, by depressing engaging head 76, spring arm 74 and engaging head 76 are caused to retract at least partially into arm recess 78 so that connecting member 32 can slide through connecting channel 30.

Further, second detent lock portion 72 is defined by a locking slot 80 disposed along connecting channel 30 for receiving engaging head 76, wherein spring member 74 directs engaging head 76 to extend into locking slot 80 for securing connecting member 32 in connecting channel 30. By depressing engaging head 76, it is retracted from locking slot 80 to allow connecting member 32 to slide through connecting channel 30. Locking slot 80 provides an opening in connecting channel 30 large enough so that engaging head 76 can move laterally to allow for rotation of connecting member 32 in connecting channel 30. Also, in a preferred embodiment, pivotal movement of spacer arm 36 in pivot gap 34 causes a complementary lateral movement of engaging head 76 in locking slot 80 so that spacer arm 36 can move fully throughout pivot gap 34.

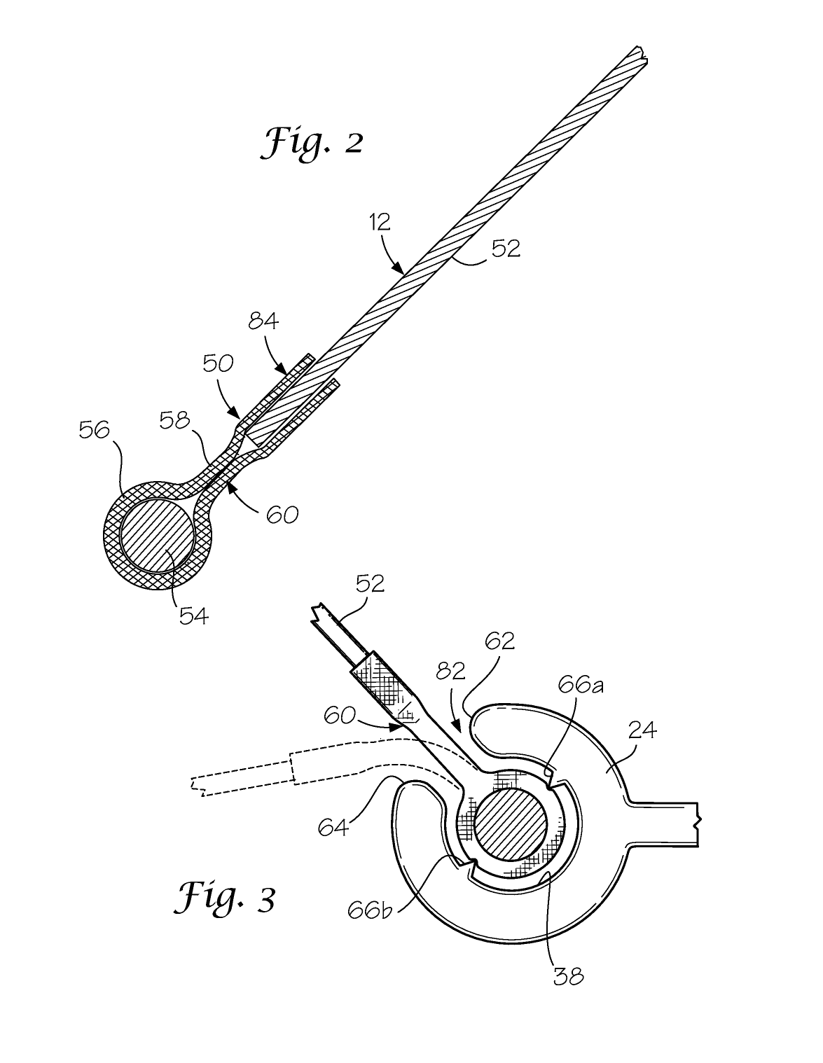

With further reference to FIG. 5A, each of the interior and end spine modules 20, 22, 24, 26 further include an accessory channel 38 for receiving one of the accessory modules. Referring to FIGS. 2 and 3, each accessory module 12, 14, 16, 18 includes a hinge connector, designated generally as 50, and an accessory panel 52 fixed to the hinge connector 50. Accessory panel 52 may take any number of embodiments, such as a pencil holding pouch, a computer tablet case, a folder, a simple plastic divider, a set of binder rings, etc. Hinge connector 50 is constructed and arranged to be received into a given accessory channel 38. Accessory channel 38 includes a hinge gap 82 defined in the walls of accessory channel 38, which are generally a c-shape arrangement, to allow hinge connector 50 of the accessory modules to extend outwardly and bend over the spine modules to pivot accessory panel 52 (See FIG. 4A).

In a preferred embodiment, hinge connector 50 comprises a non-compressible center cord 54 made of a light weight plastic material. Center cord 54 is further encased in a flexible sheet material 56, which may be selected from a variety of woven or non-woven fabrics such a nylon, or other durable flexible materials well know to those skilled in the art. Flexible sheet material 56 is stitched, glued or otherwise closed together at a first position 58 generally adjacent center cord 54 to hold center cord 54 securely in a fixed arrangement with flexible sheet material 56. The flexible sheet material 56 is then further secured to accessory panel 52, generally as position 84. The flexible sheet material 56 may be secured to accessory panel 52 by adhesives, stitching, mechanical fasteners, heat treatments and the like commonly known to those skilled in the art. Center cord 54 is laterally spaced from accessory panel 52 to define a flexible hinge section, designated generally as 60, between center cord 54 and accessory panel 52. In the illustrated embodiment, flexible hinge section 60 is formed by stitching top and bottom layers of the flexible sheet material together. When hinge connector 50 is received in accessory channel 38, the hinge gap 82 allows movement of flexible hinge section 60 between the walls defining hinge gap 82. Further, when flexible hinge section 60 engaged channel walls 62 or 64 defining hinge gap 82, the flexible nature of the material allows for further pivotal movement of accessory panel 52 as the flexible hinge section 60 bends over channel walls 62 or 64.

Referring to FIG. 3, in a further embodiment, accessory channel 38 may include at least one retainer prong 66a for engaging flexible sheet material 56 surrounding center cord 54 of hinge connector 50. In the illustrated embodiment, a first retainer prong 66a is disposed generally opposite a second retainer prong 66b in accessory channel 38 for engaging flexible sheet material 56 of hinge connector 50 to resist movement of hinge connector 50 in accessory channel 38. Retainer prongs 66a and 66b effectively pinch flexible sheet material 56 to center cord 54 in a friction fit arrangement to resist sliding and pivoting of hinge connector 50 in accessory channel 50. In this arrangement, all pivoting of accessory panel 52 results from flexible hinge section 60. The greater the distance of flexible hinge section 60, i.e. the space defined between center cord 54 and the end of accessory panel 52, the more pivotal movement can be provided for accessory panel 52.

While a preferred embodiment of the invention has been described using specific terms, such description is for illustrative purposes only, and it is to be understood that changes and variations may be made without departing from the spirit or scope of the following claims.

What is claimed is:

1. A modular binder system, comprising:
a flexible spine defined by a first spine module pivotally connected to at least a second spine module;
a first detent lock portion included on said first spine module and a second detent lock portion included on said second spine module for releasably connecting said first and second spine modules;
an accessory channel disposed in at least one of said first and second spine modules;
an accessory module including a hinge connector adapted for being received into said accessory channel and carrying an accessory panel; and,
at least one retainer prong disposed in said accessory channel engaging said hinge connector for resisting movement of said hinge connector in said accessory channel.

2. The modular binder system of claim 1 wherein said hinge connector includes a non-compressible center cord encased in a flexible sheet material that is secured to an accessory panel, and wherein said center cord is laterally spaced from said accessory panel so that said flexible sheet material forms a flexible hinge section between said center cord and said accessory panel.

3. The modular binder system of claim 1 wherein said first spine module includes a connecting member and said second spine module includes a complementary connecting channel, wherein said connecting member of said first spine module is pivotally received into said connecting channel of said second spine module.

4. The modular binder system of claim 3 wherein said connecting member extends along the length of said first spine module and said connecting channel extends along the length of said second spine module for receiving the entire said connecting member.

5. The modular binder system of claim 4 wherein said connecting member is carried at a distal end of a spacer arm so that said connecting member is projected outward, and a pivot gap is defined in a wall of said connecting channel accommodating said spacer arm to allow for said connecting member to be fully received into said connecting channel and said spacer arm to move up or down to create a pivoting connection between said first and second spine modules.

6. The modular binder system of claim 3 wherein said first detent lock portion is disposed on said connecting member and said second detent lock portion is disposed on said connecting channel for interlocking engagement when said connecting member is received into said connecting channel.

7. The modular binder system of claim 6 wherein said first detent lock portion includes a spring arm having an engaging head disposed about an arm recess of said connecting member, wherein depressing said engaging head causes said spring arm and engaging head to retract at least partially into said arm recess so that said connecting member can slide through said connecting channel.

8. The modular binder system of claim 7 wherein said second detent lock portion includes a locking slot disposed along said connecting channel for receiving said engaging head, wherein said spring arm directs said engaging head to extend into said locking slot for securing said connecting member in said connecting channel, and depressing said engaging head retracts said engaging head from said locking slot for allowing said connecting member to slide through said connecting channel.

9. The modular binder system of claim 8 wherein said locking slot provides an opening in said connecting channel in which said engaging head can move laterally to allow for rotation of said connecting member in said connecting channel.

10. The modular binder system of claim 1 wherein said accessory channel includes a hinge gap defined in the walls of said accessory channel allowing said hinge connector of said accessory modules to extend outwardly and bend to pivot said accessory panel.

11. The modular binder system of claim 1 wherein said at least one retainer prong extends continually along the length of said accessory channel for engaging said hinge connector all the way through said accessory channel.

12. A modular binder system, comprising:
a flexible spine including at least a first spine module pivotally connected to a second spine module, wherein said first spine module includes a connecting member pivotally received into a complementary connecting channel of said second spine module;
a first detent lock portion carried by said connecting member, wherein said first detent lock portion includes a spring member operatively associated with an engaging head projecting outward from said connecting member, and a recess disposed in said connecting member for at least partially receiving said engaging head when depressed so that said connecting member can slide through said connecting channel;
a second detent lock portion carried by said connecting channel, wherein said second detent lock portion includes a locking slot for receiving said engaging head, wherein said spring member directs said engaging head to extend into said locking slot for securing said connecting member in said connecting channel, and depressing said engaging head retracts said engaging head from said locking slot for allowing said connecting member to slide through said connecting channel.

13. The modular binder system of claim 12 wherein said engaging head is laterally moveably within said locking slot to allow for rotation of said connecting member in said connecting channel.

14. The modular binder system of claim 13 wherein said connecting member is carried at a distal end of a spacer arm, and a pivot gap is defined in a wall of said connecting channel accommodating said spacer arm, wherein pivotal movement of said spacer arm in said pivot gap causes a complementary lateral movement of said engaging head in said locking slot so that said spacer arm can move fully throughout said pivot gap.

15. A modular binder system, comprising:
a flexible spine defined by a first spine module pivotally connected to at least a second spine module;
an accessory channel disposed in at least one of said first and second spine modules;
an accessory module having a hinge connector for engaging said accessory channel, wherein said hinge connector includes a non-compressible center cord encased in a flexible sheet material that is secured to an accessory panel, and wherein said center cord is laterally spaced from said accessory panel so that said flexible sheet material forms a flexible hinge section between said center cord and said accessory panel; and,
a first retainer prong disposed generally opposite a second retainer prong in said accessory channel for engaging said flexible sheet material of said hinge connector to resist movement of said hinge connector in said accessory channel.

16. The modular binder system of claim 1 wherein said accessory channel includes a hinge gap defined in the walls of said accessory channel allowing said hinge connector of said accessory modules to extend outwardly and bend to pivot said accessory panel.

17. The modular binder system of claim 1 wherein said first and second retainer prongs extend continually along the length of said accessory channel for engaging said hinge connector all the way through said accessory channel.
